(19) United States
(12) Patent Application Publication
(10) Pub. No.: US 2003/0106878 A1
(43) Pub. Date: Jun. 12, 2003

(54) Method and an arrangement assisting a welding robot

(76) Inventor: Bo Sundstrom, Savar (SE)

Correspondence Address: BACON & THOMAS, PLLC, 625 SLATERS LANE, FOURTH FLOOR, ALEXANDRIA, VA, 22314

(21) Appl. No.: 10/149,417

(22) PCT Filed: Dec. 22, 2000
(86) PCT No.: PCT/SE00/02655

(30) Foreign Application Priority Data
Dec. 22, 1999 (SE) 9904790-4

(51) Int. Cl. B23K 11/30

(52) U.S. Cl. 219/86.8

(57) ABSTRACT

The present invention concerns a method and a device for automatic exchange of electrode tips for electrodes used during machine point welding, in particular, robot welding. The method during automated exchange of electrode tips during point welding, for example, when robot welding sheet metals, comprising of steps in which an electrode unit comprising holder, shaft and tip is brought into position for removal of the tip and in which the tip is gripped by one gripper (4b), whereby the shaft is gripped by another gripper (4a) and that the grippers are caused to move apart in a straight linear motion demonstrating considerable acceleration, whereby the tip is pulled loose from the shaft. The device demonstrating a demounting device (2) for demounting a tip (6) and a magazine (3) for delivery of new tips, is characterized by the demounting device demonstrating two grippers (4a and 4b) that are arranged next to each other and that can be manoeuvred linearly forwards and backwards in a manner that is rotationally stable, and by the grippers each demonstrating a gripping means (5a and 5b, respectively) for the acceptance of the shaft and the tip, respectively, whereby the gripping means (5b) that holds the tip (6) is able to pull the tip away from the shaft (7) that is held by the other gripping means (5a).

The present invention concerns a method and a device for the automatic exchange of electrode tips of electrodes during machine point welding, in particular during robot welding.

Within automatic point welding, the welding electrodes consists of a holder, through which the electrode is connected to the rest of the tool, a shaft and a tip. The tip is continuously worn down and must be exchanged at relatively regular intervals. It is normal that the tip is attached at the free end of the shaft by means of a conical clamp joint The shaft occasionally has an externally conical free end, while the tip displays a conical hole designed to be complementary to it. In such cases the tip is termed “the cap”. If the relationship had been the inverse, with a conical hole on the shaft and a conical extrusion on the tip, then the tip is termed a “top”.

Exchange of tip traditionally occurs manually using hand tools, whereby an operator grips hold of the tip by means of pliers, and the tip is then turned and removed from the shaft (it is unscrewed).

This operation has also been demonstrated carried out by a machine, in which the machine makes contact with the circumference of the tip at two points opposite to each other and in which the points of contact are displaced relative to the central axis of the tip (thus forming a turning moment) and displaced from a plane normal to the central axis, which forms components of force that unscrew the tip. In both cases, the shaft is held in its position by the carrier that is intended for normal operations (normally a robot arm).

It has, however, become evident that, in order to remove the tip from the cone of the shaft, there has arisen during the turning operations seizure between the contact surfaces between the tip and the shaft. Such damage to the cone of the shaft shortens its lifetime, impairs the fixture of the next tip and impairs the electrical contact between the contact surfaces. Furthermore, such seizures, if they lead to the fastening of the tip, risk resulting in the shaft loosening from the holder. The holder also is usually a similar conical clamp joint, although it is usually executed in larger dimensions.

When a new tip is to be mounted onto the electrode, the operation is traditionally carried out through an operator manually mounting the tip and fixing it by tapping it with a hammer.

If the particular tip demonstrates an asymmetric geometry, the operator must arrange the tip at the desired position manually, which has proved to be difficult since the requirements for repetitive precision are, in many cases, demanding.

This operation also has been mechanised by placing the tips into a carousel magazine equipped with a number of sprung gripping plates (clamps), one for each tip. By programming the robot that manages the electrode, the robot can then be caused to introduce an electrode shaft into a tip held by the sprung gripping plate. When the tip becomes attached, the robot overcomes the retaining force of the sprung plate and the magazine can turn a new tip forwards into the position for docking with an approaching electrode shaft.

The known automated magazine is technically mechanically complex and thus expensive. The extensive mechanical parts also involve the risk of insufficient reliability. If the particular tip demonstrates an asymmetric geometry, the operator must align the tip in the desired position by hand during loading of the magazine. Risks also exist here that the tips are turned to the incorrect position.

The aim of the present invention is to achieve a method and a device for robust, reliable and cost-efficient exchange of electrode tips during machine point welding.

This aim is achieved by a method and a device that demonstrates the characteristics that are specified in the following independent claims.

Embodiments of the invention can comprise special characteristics that the following subordinate claims make clear.

These and further characteristics and advantages of the invention will be made clear by the following detailed description of a preferred embodiment of the invention, which constitutes an example and is thus not limiting for the protective scope of the patent. In order to ease understanding, references are included in the text to the enclosed drawings, in which equivalent or similar parts have been given the same reference figure.

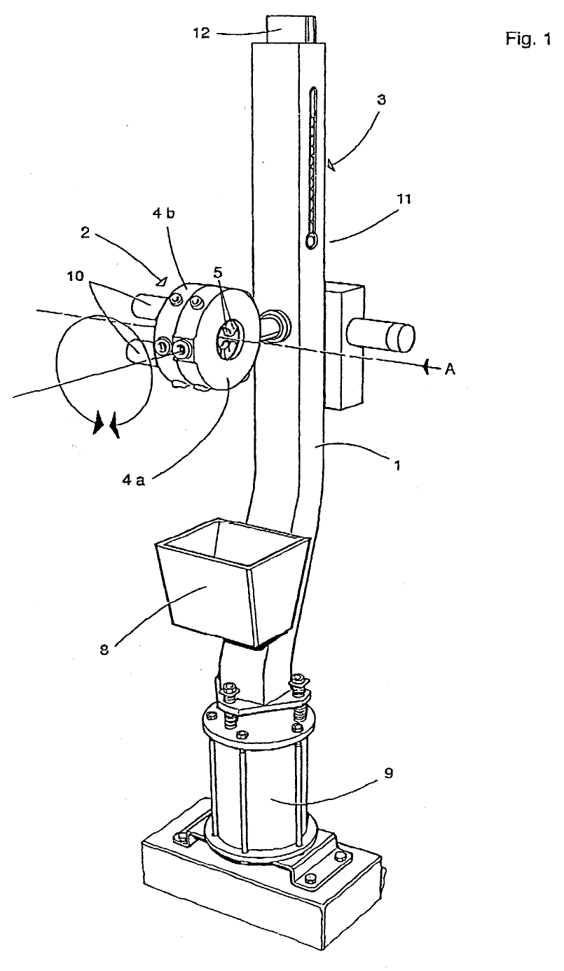

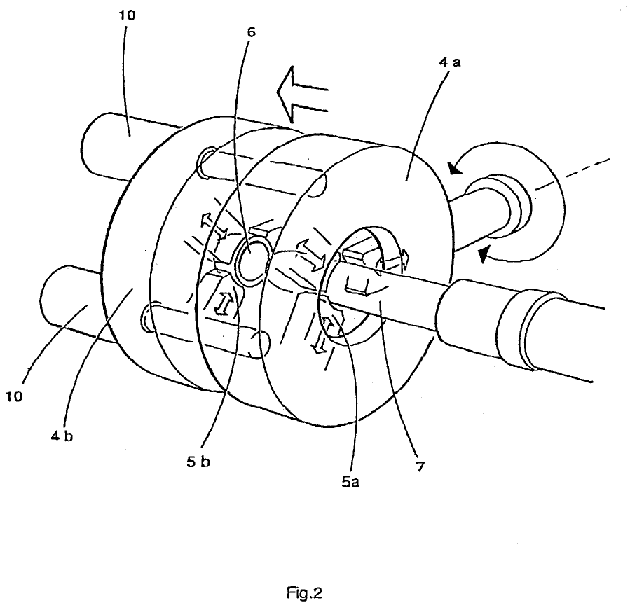

FIG. 1 shows in perspective a device according to one preferred embodiment of the present invention.

FIG. 2 shows schematically and in partial cut-away a demounting device according to one preferred embodiment of the present invention.

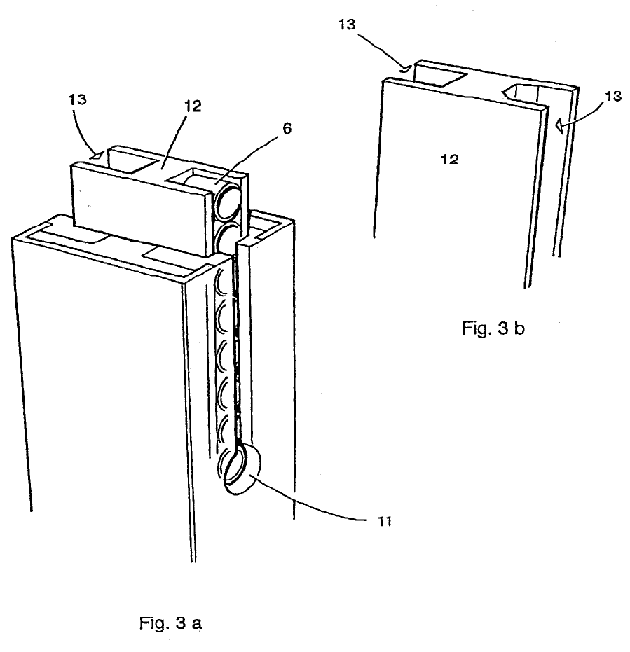

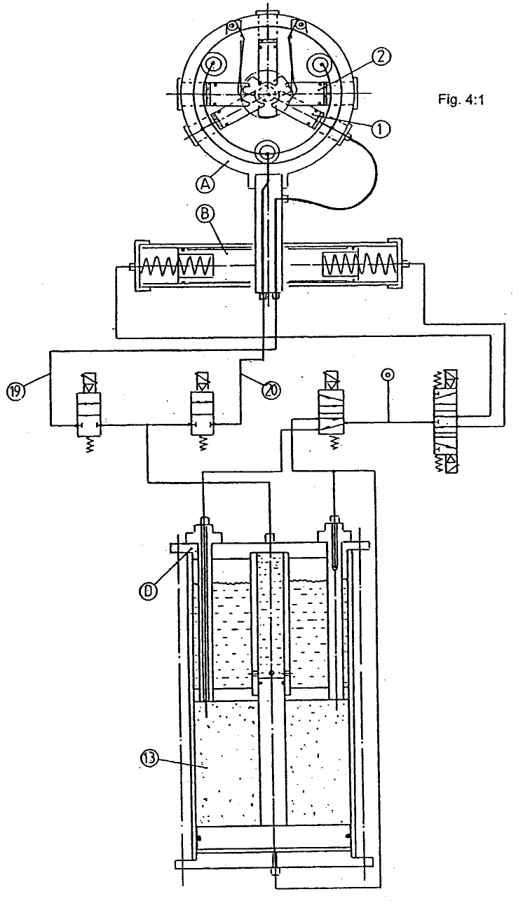

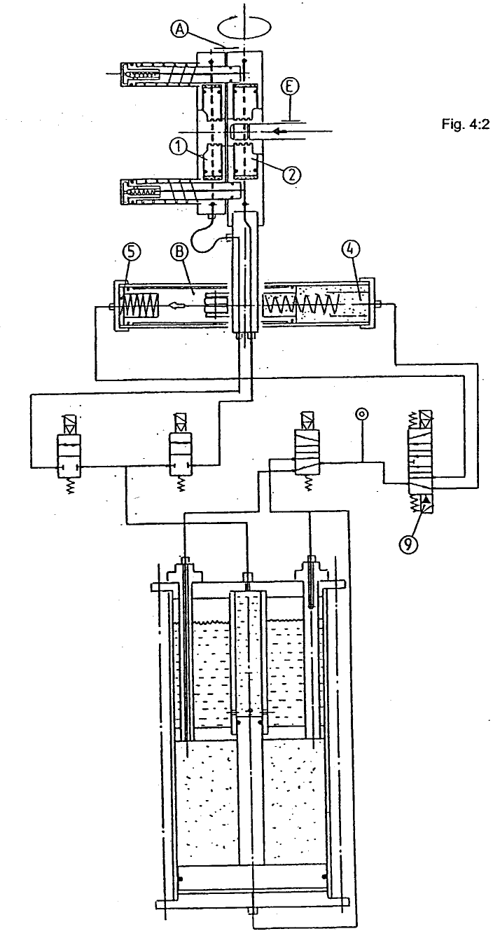

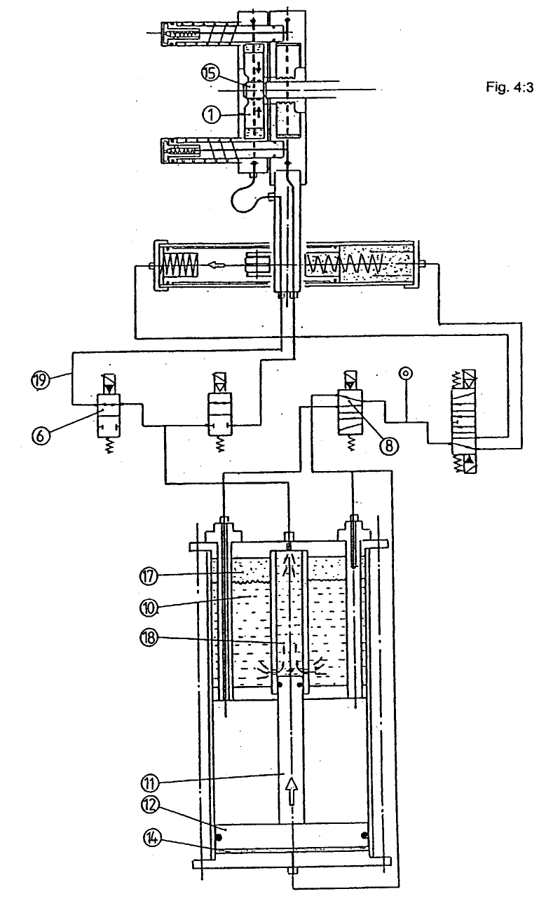

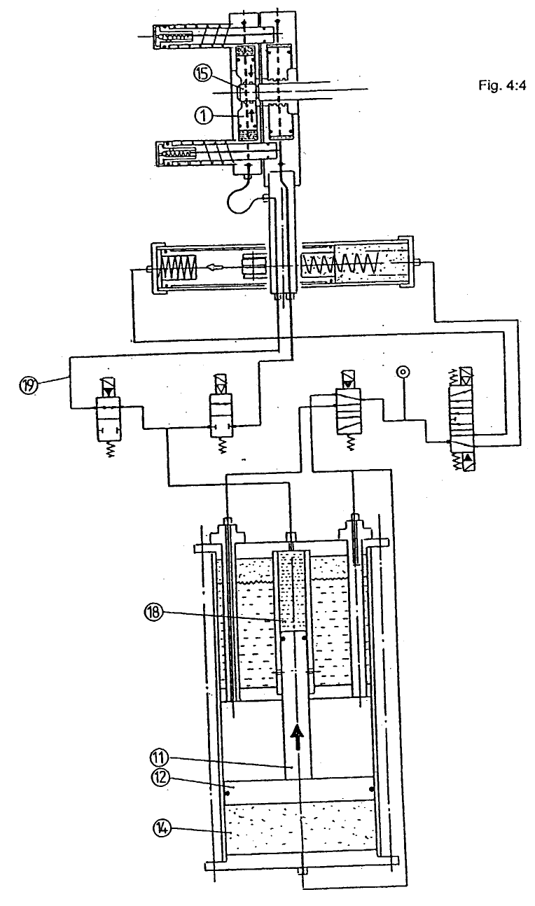

FIG. 3 shows schematically a magazine for electrode tips according to one preferred embodiment of the present invention.

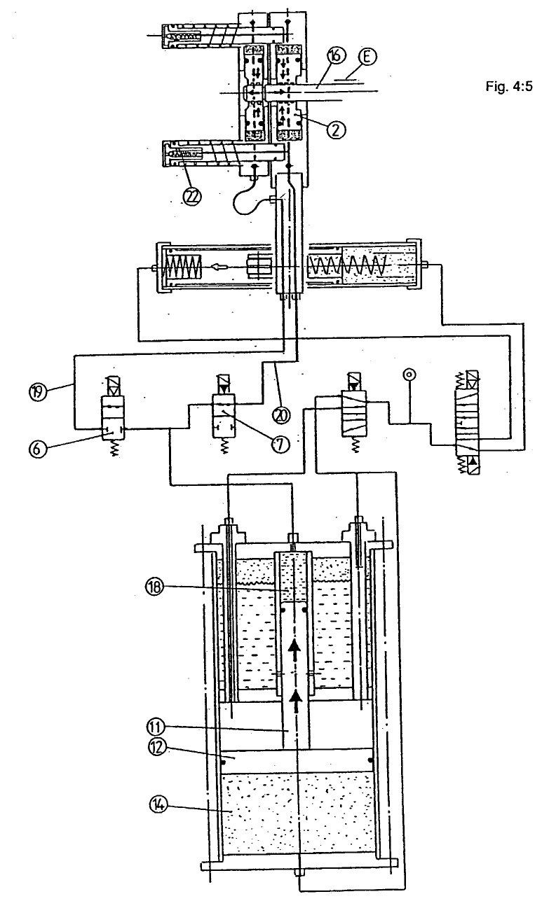

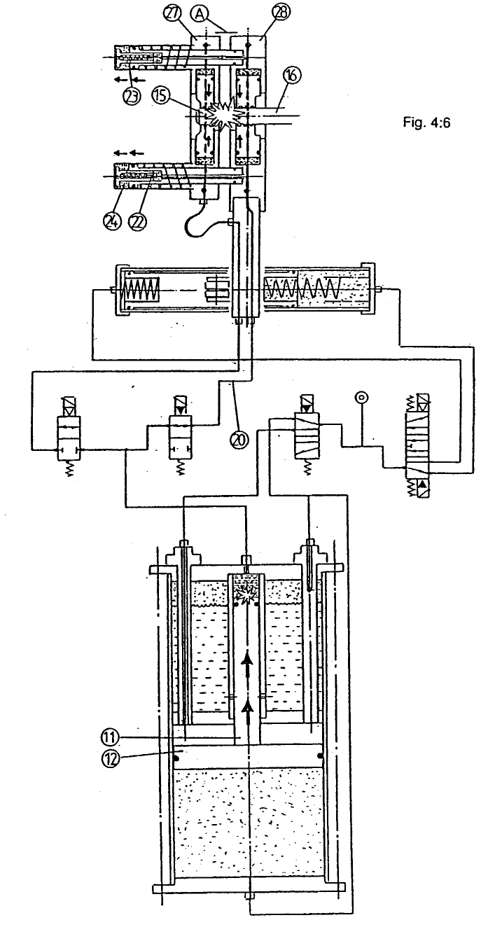

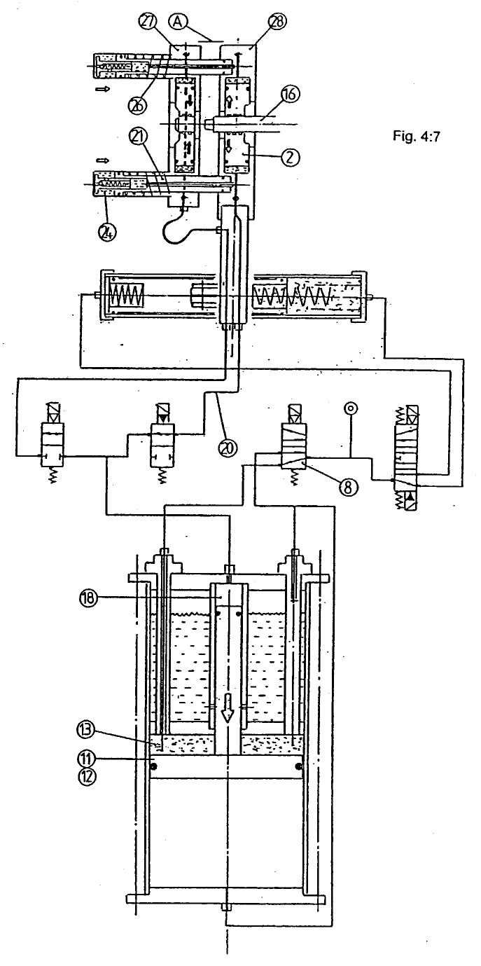

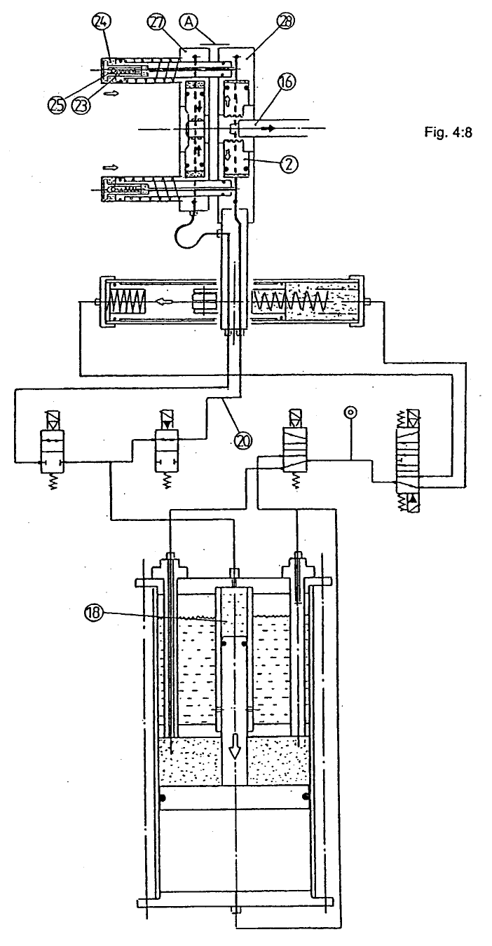

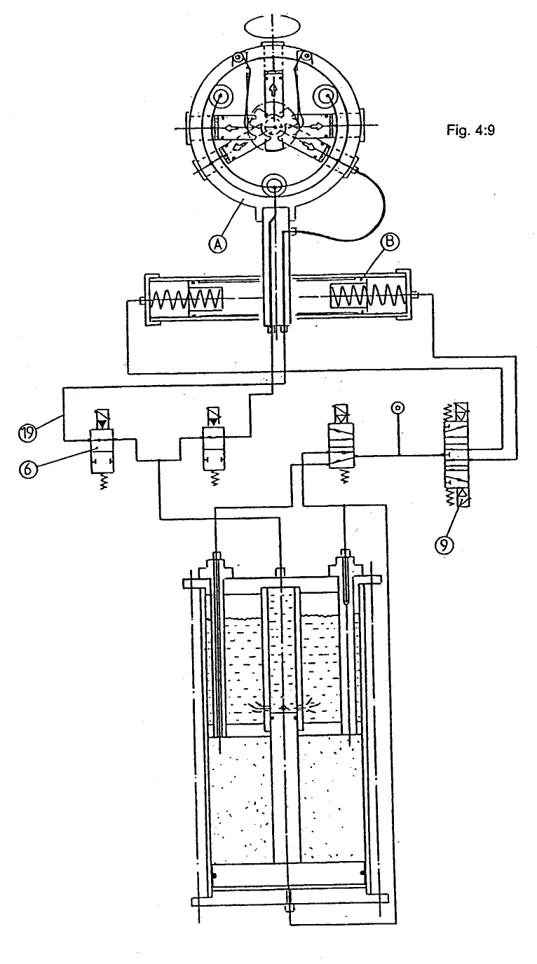

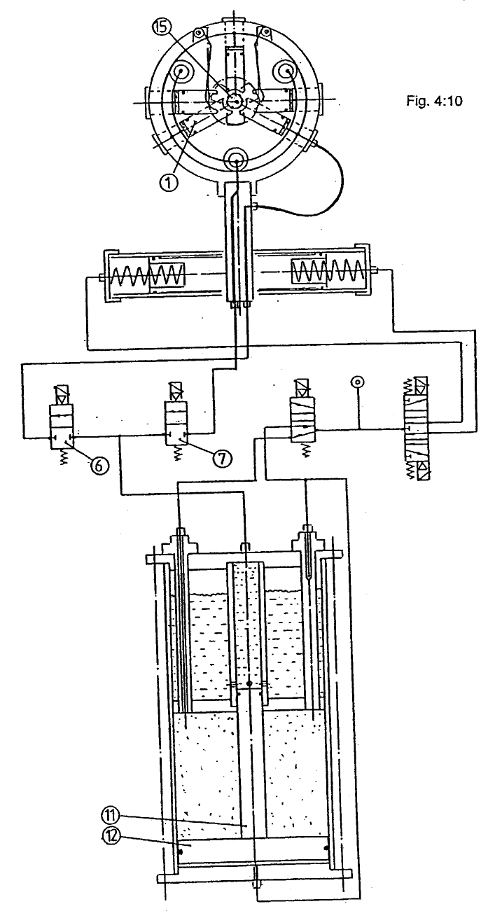

FIG. 4 shows schematically how valves and pressures manoeuvre the device according to one preferred embodiment of the present invention.

With reference to FIG. 1, an arrangement is shown according to one preferred embodiment of the present invention. The arrangement demonstrates a frame in the form of a pillar 1 bearing a demounting device 2 for demounting an electrode tip from an electrode shaft, a magazine 3 for replacement electrode tips and means for manoeuvring the constituent parts that can be manoeuvred.

The arrangement is primarily intended to be used as a service unit to one or more welding robots, which bear and manoeuvre on an arm point welding equipment that is well known for one skilled in the arts, to be used for the welding of, for example, vehicle bodies or similar.

The demounting device 2 is executed with two grippers 4, each of which demonstrates an manoeuvrable gripping means 5 for the gripping of the shaft or the tip of the electrode. In the present embodiment, both of the gripping means demonstrate a chuck-like design with three jaws arranged to be manoeuvrable forwards and backwards with respect to a central line. Both the shaft and the tip demonstrate a circular cross-section, whereby such a chuck-like design works to centre the tip and the shaft. The two gripping means of the grippers are further arranged such that they are placed opposite to each other with a common centre line, when in an open position ready to receive an electrode.

The grippers 4 are further arranged such that they can be manoeuvred away from and towards each other in directions of motion that are parallel to the said centre line. In this way, a gripped tip 6 on a gripped shaft 7 can be removed from the shaft under certain conditions.

In the present example, one gripper 4a is intended for gripping the shaft 7 and the other gripper 4b is intended for gripping the tip. The gripper 4a is arranged to rotate around the support pillar 1 between a number of defined positions. The gripper 4b is arranged next to the gripper 4a by means of three piston cylinders evenly distributed around the gripping means in order to achieve by collaboration motion relative to each other.

In a first position, shown in FIG. 1, the demounting device 2 is arranged for reception of an electrode in the direction that is suggested by the arrow A in FIG. 1. The gripping means 5 is in an open, free position. When the electrode has been introduced, the gripping means 5b of the gripper 4b, which is the inner gripper with respect to the direction of introduction A, is brought into contact with the tip 6. After this, the shaft 7 is preferably brought into contact with the gripping means 5a of the gripper 4a at the same time as the gripper 4b is driven away from the gripper 4a with considerable acceleration. A powerful acceleration is desirable in order to pull the tip loose, making it possible to remove the tip without having to be removed from the shaft by turning.

When the tip has been removed from the shaft, the gripping means 5a is released such that the robot can remove the shaft 7 from the demounting device 2.

When this has been carried out, it is an advantage if the demounting device 2 is arranged into a position in which the direction of introduction is vertical, after which, loosening of the grip around the tip 6 results in the tip being removed from the demounting device under the action of its own weight, and, for example, being allowed to fall into a collection vessel 8.

In the event of a welding tool being of larger dimensions, the demounting device 2 can be swung to a position that lies 180° relative to the previously described initial position for reception of the second electrode in the electrode pair.

It is an advantage if manoeuvring of the demounting device takes place by, for example, pneumatic, hydraulic and/or electric means.

In one embodiment, a hydraulic system is used for manoeuvring the gripping means 5 and the relative motion of the grippers 4. The hydraulic system may comprise a pressure booster 9 and two hydraulic circuits. The process involves the opening of the first circuit when the electrode is positioned in the demounting device, which causes the gripping means 5b to make contact with the tip 6 when the pressure is increased. When a predetermined pressure has been reached, the pressure circuit is sealed and at the same time the pressure that has built up in the pressure booster 9 is released with full power into the second circuit that connected both to the gripping means 5a for gripping of the shaft 7 and to the piston cylinders 10 for the mutual positioning of the gripper. A sudden jerk is achieved in this way, which removes the tip from the shaft. The pressure in the second circuit is released and the gripping means 5b releases the shaft when they have been restored by, for example, spring elements or other restoring means. A constriction in the return line of the hydraulic circuit from the piston cylinders 10 means that sufficient time is given for the shaft to be removed before the gripper 4b has returned to its initial position. It is an advantage if the return of the piston cylinders 10 also is carried out by means of the action of a spring or similar means. After this, the pressure in the circuit to the gripping means 5b is released, allowing the tip to be released. The removed tip can be allowed to fall out of the demounting device under the influence of its own weight, by suitable arrangement of the demounting device 2.

The return of the piston cylinders 10 to their initial positions can, according to one preferred embodiment, take place by the action of springs, the force potential of which has been built up during the removal of the tip. Furthermore, the return motion can be achieved by alternative means, such as hydraulic, pneumatic or electrical influence, or similar.

With reference to the flow diagram in FIG. 4: 1-10, it is shown in detail how the regulation of a device according to one embodiment of the present invention can be carried out. Note that a special set of reference figures is used in FIG. 4.

FIG. 4:1. The demounting device A is positioned by its turning means B into the neutral position with the said centre line vertically oriented. All gripping jaws 1 and 2 are open. The pressure circuits 19 and 20 are not pressurised. The pressure booster is in its resting condition with the negative chamber 13 under pressure.

FIG. 4:2. The air valve 9 has been activated such that a slide is displaced, allowing a pressure onto one of the cylinders in the turning means B for adjustment of the demounting device into a right or left position. The figure shows a right position. The cylinders in the turning means B are connected to the demounting device A and carry out the said turning when they are placed under pressure. The grip jaws 1 and 2 are open in their resting positions when an electrode E is introduced into the demounting device A.

FIG. 4:3. The tip of the electrode 15 is fixed in the demounting device by the opening of hydraulic valve 6 and the pressurisation of the hydraulic circuit 19, being applied to pistons connected to the grip jaws 1. The air valve 8 is activated and air is pressed into the expansion chamber 17 and to the positive chamber 14 of the pressure booster. Oil is then pressed from the oil chamber 10 through oil channels in the pressure cylinder 18 into the hydraulic circuit 19. The grip jaws 1 are applied to the electrode tip 15. The hydraulic pistons 11, 12 are connected together to form one unit.

FIG. 4:4. A pressure increase of the order of 1:20 occurs through pressurisation of the positive chamber 14 and the selected relative pressure areas of the pistons 11, 12. A determined charging pressure of, for example 7 bar, thus gives about 140 bar as output from the pressure cylinder 18. The hydraulic circuit 19 is pressurised to a higher degree. The grip jaws 1 now grip with full power onto the electrode tip 15.

FIG. 4:5 The hydraulic valve 6 is deactivated. The pressure achieved is accumulated in the hydraulic circuit 19. The hydraulic valve 7 is activated and opens into to the hydraulic circuit 20. Pressurised oil flows into the hydraulic circuit 20. The flow of oil causes the grip jaws 2 to move towards the electrode shaft 16, whereby the movement of the grip jaws causes a pressure decrease in the pressure cylinder 18. The pressure in the positive chamber 14 causes, due to said sudden fall in pressure, the pistons 11, 12 to accelerate rapidly, upwards in the drawing. When the grip jaws 2 reach the shaft, the flow is instantaneously stopped. The circuit 20 becomes pressurised. The pressure is distributed through the circuit between the grip jaws 2 and the throttle reverse valves 22. Through the design and the dimensions of the pistons 2, 22, a balance is achieved between the holding force and the drawing force that act on electrode E such that the greater the drawing force that is required, the greater the holding force that is created. The holding force must be larger than the drawing force. However, the difference between them is striven to be kept as little as possible, without the grip jaws 2 losing grip and gliding along the electrode shaft 16.

FIG. 4:6. When the flow in the hydraulic circuit 20 is instantaneously stopped, the pressure pistons 11, 12 are rapidly braked. A pressure pulse arises in the circuit 20 due to the rapid braking and the mass of the pistons. This instantaneous pressure pulse pulls the electrode tip 15 away from the electrode shaft 16. The instantaneous pressure pulse influences the throttle reversing valves. Their pressure surfaces press the rear grip housing 27 of the demounting device A away from the grip housing 28, whereby the oil channel 23 opens to the positive chamber 24 of the draw cylinder. The balance between drawing force and holding force ceases when oil flows into the positive chamber 24 of the draw cylinder.

FIG. 4:7. When the valve 8 is deactivated, the negative chamber 13 of the pressure piston becomes pressurised. The oil pressure is evacuated in 18, 20 and 24. The grip jaws 2 release with the aid of the spring return their grip around the electrode shaft 16. The return springs 26 in the draw cylinder 21 cause the rear grip housing 27 to return to the forward grip housing 28.

FIG. 4:8. When the return occurs, the oil channels 23 of the throttle reversing valve are closed. Oil contained in the positive chambers 24 of the draw cylinders is pressed through the ball valves 25 of the throttle return valves. Thus the return stroke of the rear grip housing 27 to the forward grip housing 28 takes places slowly. The pressure cylinder 18 and the cylinder 20 of the hydraulic circuit loose pressure, The grip jaws 2 open fully. The electrode shaft 16 can be removed backwards from the demounting device A.

FIG. 4:9. Valve 9 is deactivated from its right position (or left position). The turning means B causes the demounting device A to return to its resting position (with the centre line oriented vertically). Valve 6 is activated and pressure is evacuated from circuit 19.

FIG. 4:10. The grip jaws 1 release with the aid of the return spring their grip on the electrode tip 15. The pressure pistons 11, 12 move to the neutral position and the hydraulic valves 6 and 7 are deactivated. The electrode exchanger has now returned to its resting condition.

Discussion now returns to FIGS. 1-3 and the normal set of reference figures.

A pneumatic turning means of known type can advantageously be used for manoeuvring the turning position of the demounting device 2 relative to the pillar 1.

When the tip 6 has been removed from the shaft 7 and the robot has recovered the shaft from the demounting device 2, the intention is that the robot should be programmed to introduce the coned end of the shaft into a new electrode tip, which is located in the outlet 11 of the magazine 3. Since the free end of the shaft is introduced into the new tip with a certain force (or to a certain position), the new tip is attached either to a sufficient degree for immediate use, or at least to sufficient degree such that it accompanies the electrode shaft in a motion, well known within the field, in which the electrodes of the spot welder are brought together in order to make contact with the exchanged electrode with a suitable force.

The magazine 3 for tips that is shown here will hereunder be described in more detail, with particular reference to FIG. 3.

The magazine 3 comprises an outer housing, which in the example shown constitutes part of the pillar 1, but may also be a free-standing unit. A strip 12 is arranged inside the housing demonstrating at least one track 13 that extends in the longitudinal direction of the strip for carrying therein of a number of electrode tips 6. The strip 12 is further intended to be carried in the housing in such a position that electrode tips arranged in a row along the track 13 of the strip are fed forwards, preferably by the action of their own weight, when the electrode tip placed under or in front of the tips is removed through an opening in the housing. The opening has previously in the text been referred to as the outlet 11.

It is an advantage for this if the track 13 of the strip is arranged vertically, with the opening in the housing at the same level as the tip that is located farthest forward, lowest in this case, in the track.

It would, of course, be possible to give the strip and the housing another orientation provided that a power means, such as a spiral spring or similar, is added for driving forwards tips that lie subsequently in the track.

It is preferable if the track 13 is adapted to the tips such that these receive support such that their position can be predicted, which is an advantage when a robot is to be programmed in order to introduce a shaft into the tip.

The track may also be designed such that it can, for tips whose external geometry is asymmetric, ensure that these tips have a predetermined orientation when they are located at the outlet 11. This can occur in that the track is given a cross-section 13′ that is executed to be complementary in relationship to a particular type of electrode tip.

The strip can be produced by different methods, moulding, milling, etc. It is produced in one preferred embodiment by extrusion moulding of a profile strip that can be cut to the desired length. A stop can be arranged in the track of the profile, constituting an end position for arrangement of the tips that have been introduced into the track in a certain position for output feeding. This stop or end position can, naturally, be arranged for the same purpose in the housing, or it can be constituted by termination of the track of the strip.

Thus, in the embodiment shown, the magazine from which new tips are to be fetched by the robot is arranged at the top of and inside the pillar 1. The robot inserts the electrode shaft through the outlet 11. The tips are arranged in a queue in a track 13 inside the outlet. In the direction upwards, viewed from the outlet 11, a track that is narrower than the external dimensions or diameters of the tips is arranged, such that it is possible to view the number of tips remaining in the track of the magazine. When a tip has been removed through the outlet 11, the tips above it fall down by one step towards the end position and a new tip is ready to be fetched through the outlet 11.

The magazine is equipped in the present embodiment with two outlets for tips. One reason for this is to enable the welding machine to fetch new tips from two directions. Another reason is to be able to serve a welding machine with two different types of electrode tips. The possibility should exist, for example, to offer a symmetric tip for one of the electrodes of the tool and an asymmetric tip for the other electrode. Consequently, the strip is also executed with two tracks. Furthermore, two strips can be arranged within the same housing to form two different magazine units in the same housing if this is to be preferred.

By arranging movable lower boundary positions, a strip with, for example, one track for asymmetric and one track for symmetric tips can be arranged by twisting and/or turning upside down, such that different positions and directions can be achieved for the tips using only one strip in the magazine.

The pillar in the present embodiment is further equipped with means for absorbing positional variations in docking electrodes. FIG. 1 shows how elastic elements in the form of rubber bushes are arranged in association with the mounting of the pillar on the support base or foundation.

End-switches are arranged in association with the elastic elements in order to react if abnormal forces influence the pillar 1. In the event of the robot making oblique or in any other way faulty contact and bending the pillar past a predetermined allowed maximum level, the bending is absorbed by the elastic elements and recorded by the end-switches. The signals from the switches are used to stop the robot and alert an operator.

The method according to the described embodiment involves, with reference to FIG. 1, the robot that carries the welding equipment introducing one of the electrodes into the demounting device 2. In this position, the tip 6 is gripped by the gripper 4b. Once the grip is secure, the shaft 7 is gripped by the gripper 4a and the grippers 4 are caused to separate in a rotationally stable linear motion, whereby the tip is drawn from the shaft. It is preferable if the gripping of the shaft is complete before the sudden jerk that facilitates the removal of the tip occurs.

The embodiments described above have been based on the use of straight electrode shafts. The protective scope of the invention includes in alternative embodiments also a gripper 4a executed without a gripping means 5a, but equipped instead with a seat or a contact surface for at least one part of a curved electrode shaft. The method is otherwise the same as that described.

The gripper 4a in a further embodiment is equipped both with a gripping means for gripping a straight shaft and a seat for the support of a curved shaft during the pulling loose of the tip.

Even if an arrangement executed as one unit has been described here, it is clear for one skilled in the arts that the constitutive components, in particular the demounting device and the magazine, can be used independently of each other and in other design solutions, which also lie within the protective scope of the present invention.

1. A method for the automatic exchange of electrode tips during point welding, for example, when robot welding sheet metals, comprising of steps in which an electrode unit comprising holder, shaft and tip is brought into position for removal of the tip and in which the tip is gripped by one gripper (4b), the shaft is gripped by another gripper (4a) and that the grippers are caused to move apart in a straight linear motion demonstrating considerable acceleration, whereby the tip is pulled loose from the shaft characterised in that a circuit is arranged for each gripping means, that the circuit that manoeuvres the gripping means (5a) that grips the shaft is at the same time connected to the means (10) of separating the grippers, and that the latter manoeuvring circuit is connected through a pressure-increasing device for initiation with direct high pressure, achieving a high acceleration of the gripping means (5a) that grips the shaft and the means (10) for separating the grippers.

2. The method according to claim 1, characterised in that the shaft is gripped at the same time as the initiation of the straight linear motion.

3. The method according to, claim 2, characterised in that when the tip has been removed, the grip on the shaft is released and the shaft is removed from the demounting device and that the shaft is introduced into a tip held in a definite position by a magazine.

4. A device for the execution of the method according to claim 1, demonstrating a demounting means (2) for demounting a tip (6) and a magazine (3) for delivery of new tips, the demounting device demonstrates two grippers (4a and 4b) that are arranged next to each other and that can be manoeuvred linearly forwards and backwards in a manner that is rotationally stable, and that each of the grippers demonstrates a gripping means (5a and 5b, respectively) for the acceptance of the shaft and the tip, respectively, whereby the gripping means (5b) that holds the tip (6) is able to pull the tip away from the other gripping means (5a) that holds the shaft (7), characterised in that a circuit is arranged for each gripping means, that the circuit that manoeuvres the gripping means (5a) that grips the shaft is at the same time connected to the means (10) of separating the grippers, and that the latter manoeuvring circuit is connected through a pressure-increasing device for initiation with direct high pressure, achieving a high acceleration of the gripping means (5a) that grips the shaft and the means (10) for separating the grippers.

5. The device according to claim 4, characterised in that linearly operating draw cylinders are arranged to be manoeuvred between the grippers (4a and 4b) achieving the linear forwards and backwards relative motion of the grippers.

6. The device according to claim 4 or 5, characterised in that the demounting device is mounted in a manoeuvrable manner, whereby the demounting device is able to be arranged in at least one predetermined position.

7. The device according to any one of claims 4-6, characterised in that the magazine (3) comprises an oute housing, a strip (12) internal to the housing demonstrating at least one track (13) that lies along the longitudinal direction of the list for the carrying therein of a number of electrode tips (6) and in that openings or outlets (11) are arranged in the housing for removal of tips from the magazine.

8. The device according to claim 7, characterised in that the strip (13) in the housing is arranged in such a position that electrode tips (6) arranged in a row along the track (13) of the strip are fed forwards, preferably by the action of their own weight, when the electrode tip placed under or in front of [the tips] is removed from the outlet (11).

9. The device according to any one of claims 7 or 8, characterised in that a means of force is arranged in connection with the track for driving forwards of tips placed in the track, whereby a spiral spring, elastic straps or similar, for example, can be used as the means of force.

10. The device according to any one of claims 7-9, characterised in that the track (13) is so designed with respect to the tips that these receive support such that their position can be predicted, preferably that the track is so designed that it can be ensured that those tips whose external geometry is asymmetric have a predetermined orientation when they are placed in the outlet (11), whereby the track is given a cross-section (13′) that is executed to be complementary relative to the particular type of electrode tip.

11. The device according to any one of claims 7-10, characterised in that movable end positions are arranged in the track of the strip, whereby, for example, a strip with one track for asymmetric tips and one track for symmetric tips can be arranged by twisting and/or turning upside down, such that different positions and directions can be achieved for the asymmetric tips using only one strip in the magazine.
